(19) United States
(12) Patent Application Publication
(10) Pub. No.: US 2011/0179398 A1
(43) Pub. Date: Jul. 21, 2011

(54) SYSTEMS AND METHODS FOR PER-ACTION COMPILING IN CONTACT HANDLING SYSTEMS

(75) Inventor: David Owen Peterson, Lehi, UT (US)

(73) Assignee: INCONTACT, INC., Midvale, UT (US)

(21) Appl. No.: 12/688,690

(22) Filed: Jan. 15, 2010

(51) Int. Cl. G06F 9/44

(52) U.S. Cl. 717/115

(57) ABSTRACT

One example embodiment includes a method for compiling one or more scripts on a per-action basis. The method includes receiving a script including one or more actions to be accomplished by a script application. The method further includes determining if the script has been previously compiled and determining if the script has been changed since it was last compiled. The method further includes retrieving the compiled script from a memory if the script was previously compiled and if the script has not been changed since it was last compiled. The method further includes compiling the script if it has not been previously compiled or if the script has been changed since it was last compiled. Compiling the script includes translating the script from source code to machine code, saving the machine code to the memory and identifying the script as compiled. The method further includes executing the compiled script.

### CROSS-REFERENCE TO RELATED APPLICATIONS

This application relates to co-filed U.S. patent application Ser No. ______ entitled “SYSTEMS AND METHODS FOR REDUNDANCY USING SNAPSHOTS AND CHECK POINTING IN CONTACT HANDLING SYSTEMS” (Attorney Docket No. 17179.13) filed on Jan. 15, 2010, and co-filed U.S. patent application Ser. No. ______, entitled “SYSTEMS AND METHODS FOR MULTI-TENANCY IN CONTACT HANDLING SYSTEMS” (Attorney Docket No. 17179.14) filed on Jan. 15, 2010, which applications are incorporated herein by reference in their entirety.

### BACKGROUND OF THE INVENTION

Contact handling systems guide the interaction between customers and business processes using any commonly-used form of media. A contact is typified by an incident of communication exchange between a customer and a business process of a business. A business may have total or partial use of a contact-handling system. Often the business process is handled by a representative of the business called an agent. For example, agents can include employees, supervisors, and administrators, and the contact media can include telephone calls, email, survey feedback, etc. Often, contact handling can include receiving calls, or other contact media, in behalf of one or more businesses from customers who wish to obtain products, services, or information. A customer is a person seeking interaction with a process of a business or a person who is sought for interaction by the business. A business process involves a set of steps taken by business representatives and automated equipment to initiate or respond to contacts. Examples include sales, product returns, technical support, or automated information requests (e.g. information provided via recorded voice or fax-back). For example, contact handling can include receiving telephone calls, or interaction via other communication media, from customers who need customer service help, customers who need to check on account balances, customers who are seeking further information regarding a product or potential purchase, or customers who require any other type of assistance.

Contact handling may include a business representative who speaks with the customer on the phone. In addition, contact handling may include an Interactive Voice Response (IVR) unit providing recorded messages which directly supply the requested information, or prompt a customers to enter certain information either using their telephone keypad or by speaking the information aloud, such information to be used by the business process. Further, contact handling may include some combination of interaction with recorded messages and a business representative. For example, if a customer is calling to obtain information, the customer may be prompted by a recorded message to enter certain information through their telephone keypad. The customer may then be connected to a business representative, who then completes the business process.

Accordingly, a stable connection between the contact handling system and the customer is essential. If the connection is not reliable, the customer may be disconnected from the contact-handling system and become frustrated. As a result, they may refuse to call back and complete the transaction, or may take their business elsewhere. If a large number of calls are dropped or mishandled, a business paying for contact handling services might transfer their processes to an alternative contact handling provider. Unfortunately, there are a number of vulnerabilities in typical contact handling systems which may allow contact handling services to be dropped or mishandled.

In particular, any contact handling system will experience sub-system failures from time to time. The failure may be caused by the system's software, the system's hardware or both. If the software which is designed to obtain the required information is not configured correctly or contains bugs, for example, the software may fail to obtain the required information or may disconnect the contact at an inappropriate time. For example, the contact handling system may drop a telephone connection between the customer and an agent. Alternatively, the software may contain improperly programmed script loops which repeatedly prompt the customer to enter the same information.

Additionally, the software that traditionally runs a contact handling system may be quite complex. This results from the fact that the software may need to interpret a number of different options for the customer to select. Each of these options may include sub-options that are presented to the customer based on previous selections by the customer. If a change is made to any one of the options or sub-options, the entire program may need to be reconfigured, recompiled or both. In addition, debugging the program becomes exponentially more difficult as the program gets larger and more complex.

Further, the complexity of the software may mean that each script requires assistance from a programming expert in order to create the software. Therefore, if a large number of scripts need to make changes at the same time, the programmers may become overwhelmed by the workload. Alternatively, the programmers may become under worked if a large number of scripts are not making changes to their program.

Alternatively, the hardware may fail to execute the software correctly. For example, if multiple contacts use the same hardware within the contact handling system, a problem in the software of one contact (such as an unintended infinite loop) may cause the hardware to remain unavailable to other contacts using the same hardware. This can, in turn, cause a bottleneck which prevents the use of even more hardware in the contact handling system. This monopolization of hardware can be alleviated by providing unique hardware to each contact. However, providing unique hardware for each contact can become expensive. In particular, certain hardware may be under-utilized much of the time or under-utilized during certain times of the day thus leading to under-utilization of resources.

Accordingly, a contact handling system is needed which simplifies the process of creating custom contact handling software that can handle contact media in an easily-customizable manner. Ideally, contact handling systems would provide system stability even if a portion of the system suffers a failure. A further ideal would be contact handling systems and methods that allow contact handling hardware multi-tenancy while preventing any one contact or business from consuming a disproportionate amount of the system resources.

The subject matter claimed herein is not limited to embodiments that solve any disadvantages or that operate only in environments such as those described above. Rather, this background is only provided to illustrate one area of technology where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a user interface for allowing a business to create a script application from one or more scripts in a visual environment. The user interface includes a script menu. The script menu includes one or more script actions for a business to select from. A script includes one or more actions to be accomplished by a script application. The one or more scripts are represented in the graphical user interface as sets of “action” icons which can be manipulated by the business and the icons include a visual representation of branches within each of the one or more scripts. The branches represent options that can be selected by a customer in communication with a contact handling system if the script includes a customer-selectable option and the branches are configured to connect to additional actions within the script. The user interface further includes a frame, where the frame is configured to allow a business to visualize the one or more actions and to assemble the one or more scripts into the script application.

Another example embodiment includes a method for compiling one or more scripts on a per-action basis. The method includes receiving a script. The script includes one or more actions to be accomplished by a script application. The method further includes determining if the script has been previously compiled and determining if the script has been changed since it was last compiled. The method further includes retrieving the compiled script from a memory if the script was previously compiled and if the script has not been changed since it was last compiled. The method further includes compiling the script if it has not been previously compiled or if the script has been changed since it was last compiled. Compiling the script includes translating each action of the script, individually, to machine code, saving the machine code to the memory and identifying the script as compiled. The method further includes executing the machine code Actions of the compiled script.

Yet another example embodiment includes a computing system for per-action compiling a computer program. The computing system includes a receiver module. The receiver module includes a first module configured to receive a script application, where a Script Execution Engine is configured to execute one or more scripts and a second module configured to receive the one or more scripts, wherein the one or more scripts include one or more actions to be accomplished by the Script Execution Engine. The computing system further includes a third module configured to compile scripts, where the third module compiles each of the one or more script actions individually and where compiling each of the one or more script actions individually includes translating the script action from source representation to machine code. The computing system further includes a fourth module configured to save each of the one or more compiled script actions to a memory.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a contact handling system which allows for per-action compiling and redundancy in a multi-tenant environment;

FIG. 2 illustrates a graphical user interface that can be used to add scripts to a script application;

FIG. 3 illustrates a block diagram of a per-action compiler;

FIG. 4 is a flow diagram illustrating a method for per-action compiling a script;

FIG. 5 is a flow diagram illustrating an alternative method for per-action compiling a script;

FIG. 6 illustrates an example of a system for per-action compiling a script;

FIG. 7 is a flow diagram illustrating a method for providing multi-tenancy in a computing environment;

FIG. 8 illustrates an example of a system for providing multi-tenancy in a computing environment;

FIG. 9 is a flow diagram illustrating a method for building an action list in a multi-tenant environment;

FIG. 10 is a flow diagram illustrating a method for providing redundancy using check pointing and snapshots;

FIG. 11 illustrates an example of a system for providing redundancy using check pointing and snapshots;

FIG. 12 is a flow diagram illustrating a method for executing a script in a second computing environment if a failure occurs in a first computing environment; and

FIG. 13 illustrates a suitable computing environment in which embodiments may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

### I. Examples of Contact Handling Systems

Many of the improvements in contact handling systems which may result from the teachings disclosed herein relate to ensuring that a customer remains connected to the contact handling system in the event of a failure of one or more components of the contact handling system, including hardware and software. For example, the improvements in contact handling systems can include a computing environment that includes Windows Services, databases, web applications, and executable applications running on state-of-the-art multi-processor servers or other hardware or software for implementing a contact handling service. These services can be installed on servers spanning separate physical locations which provide geographic redundancy, allowing the contact handling system to remain functional in the event of a failure, including failure of telephone, internet, or electrical services, in one of the geographical locations.

The two running services, also referred to as service instances, communicate with each other to duplicate in-memory state data in real time through the use of check pointing and snapshots, as discussed below in section IV. In each running service a script execution engine can run high-level applications known as scripts. Each script performs a specific action, from making a simple decision, requesting specific information, relaying information to a customer, queuing a call for the next available agent or any other service desired by a business. Companies can assemble one or more scripts together in script applications which can present a large variety of options to a customer. Companies can be, therefore, empowered to build very simplistic or extremely sophisticated script applications to fulfill individual business requirements.

A script is a set of individual script actions, interconnected by logic pathways, which direct the flow of logic for some portion of a contact. A script action (or simply action) is a discrete logic element which performs a macro function such as place call, transfer, play recorded file, etc. In the state of the art, scripts are graphically rendered for creation and modification. For the purposes of this application, a script application is a set of scripts which together embody the logic needed to guide the proceedings of a contact. Different kinds of contacts often require different script applications. For example, a phone-initiated contact requires a different script application than an email-initiated contact. A script execution engine is a piece of software or hardware that executes one or more actions contained within the scripts one at a time.

Additionally, improvements in contact handling systems allow for multi-tenancy, or the ability to serve the script applications of more than one distinct and independent business on the same physical equipment within the contact handling system, as discussed below in section III. When a script application is executed, it allocates the needed resources and runs to completion. However, if two or more script applications need to run concurrently, they must compete with each other for the available resources. The result is that each script application may run less efficiently. In particular, if a problem occurs within one script application, it can consume high levels of system resources, thus depriving other script applications of the necessary resources. A well-written and well-behaving script application is usually very fast and can use resources efficiently, but a poorly-written script application runs slowly and uses resources inefficiently. Splitting each script application into individually-compiled script actions and allowing each script application to only execute one script action at a time can control the resource use of the script application and prevent a single tenant script application from requiring too much memory, too many CPU cycles or otherwise preventing other script applications from accessing computing resources.

In addition, improvements in contact handling systems allow for each script to be built and compiled separately from one another, even if scripts are to work with one another in a single script application, as discussed below in section II. Building and compiling scripts independent of one another can preserve system resources in the contact handling system. For example, a single script application can contain anywhere from a single script up to multiple dozens of scripts. However, individual compilation of each script action can mean that changes to a single script within the script application results in only the changed script being recompiled, rather than all scripts within the script application. Additionally, as discussed below in section II, each script can be compiled when it is first executed, thus preserving system resources until compilation is needed. Thus, as a result of the teachings disclosed herein, customer satisfaction, employee satisfaction, and revenue may be improved in the contact handling industry.

While employment of the teachings disclosed herein may produce particular benefits in the contact handling industry, such teachings may produce similar benefits in other industries as well, and therefore, are not limited to the contact handling industry. Moreover, as used herein, the term “business representative” includes call center agents, sales team agents, support employees, employees of a business, or agents hired to represent a business in a contact handling system. For example, a business representative can include an employee of a contact handling system who is responsible for handling customers that relate to a particular business. Additionally or alternatively, a business representative can include an employee of a business which purchases or leases contact handling systems or software.

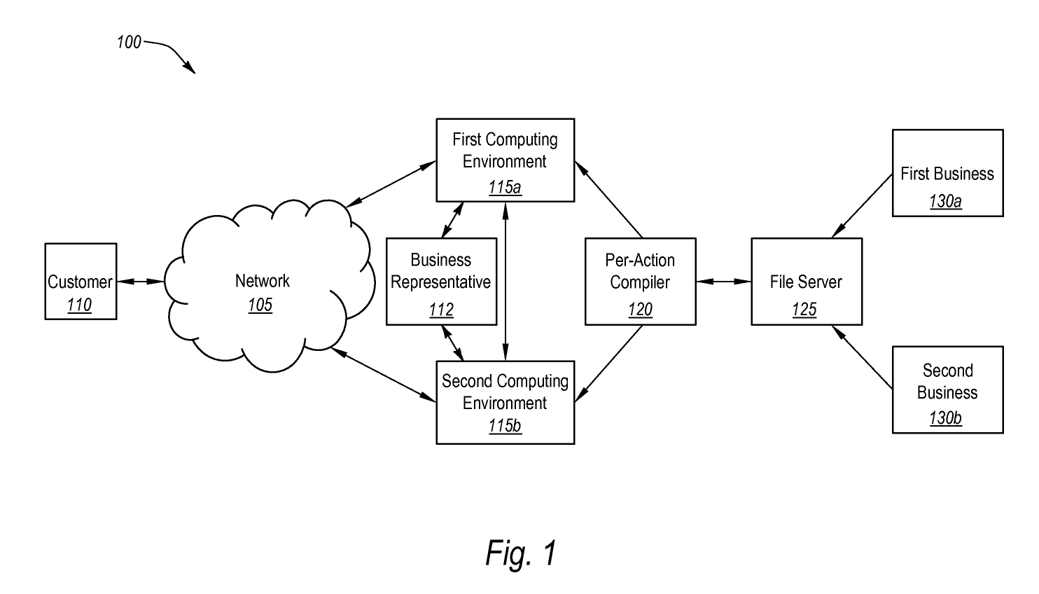

FIG. 1 illustrates a block diagram of a contact handling system 100 which allows for per-action compiling and redundancy in a multi-tenant environment. In at least one implementation, the contact handling system 100 can be used to provide fault tolerance in the event of a single hardware or software entity failing. In particular, contact handling firms and other businesses rely on telecommunications systems to work properly in order for their business to succeed. Failure of the contact handling system 100 can lead to lost sales, lost revenue or the loss of customers. Accordingly, it is of high importance that the contact handling system 100 be able to recover seamlessly in the event of a fault.

FIG. 1 shows that the contact handling system 100 includes a network 105. In at least one implementation, the network 105 allows a customer 110 to communicate with the contact handling system 100. For example, the network 105 can include a telephone network. A telephone network can allow a customer to place a telephone call to or receive a telephone call from the contact handling system 100. For example, the network 105 can include the public switched telephone network (PSTN). The PSTN is the network of the world's public circuit-switched telephone networks, or the networks set-up by telephone companies and governments to provide telephone access to homes and businesses. The PSTN can include analog or digital systems and can include fixed or mobile telephones.

Additionally or alternatively, the network 105 can include a computer network that allows email, chat, or voice over internet protocol (VOIP). VOIP can include a family of transmission technologies for delivery of voice communications over IP networks such as the Internet or other packet-switched networks. The Internet includes a global internetwork formed by logical and physical connections between multiple wide area networks and/or local area networks and can optionally include the World Wide Web (“Web”), comprising a system of interlinked hypertext documents accessed via the Internet. Alternately or additionally, the network 105 can include one or more cellular RF networks and/or one or more wired and/or wireless networks such as, but not limited to, 802.xx networks, Bluetooth access points, wireless access points, IP-based networks, or the like. The network 105 may also include servers or other switches that enable one type of network to interface with another type of network.

FIG. 1 also shows that the network 105 is connected to a customer 110. In at least one implementation, the customer 110 can include any person that becomes connected to the contact handling system 100. In particular, the customer 110 can include a customer who has called the contact handling system 100 via a conventional telephone or cellular phone.

FIG. 1 further shows that the contact handling system includes a business representative 112. In at least one implementation, the business representative 112 can connect with the customer 110 through the network 105 and either a first computing environment 115a or a second computing environment 115b (collectively “computing environment 115”). For example, the business representative 112 can include an operator who is speaking directly with a customer who has called the contact handling system 100 via a conventional telephone or cellular phone. Additionally or alternatively, the business representative 112 can be prompted by the contact handling system 100 to obtain certain information from a customer and enter the information into the contact handling system 100.

### II. Per-Action Compiling

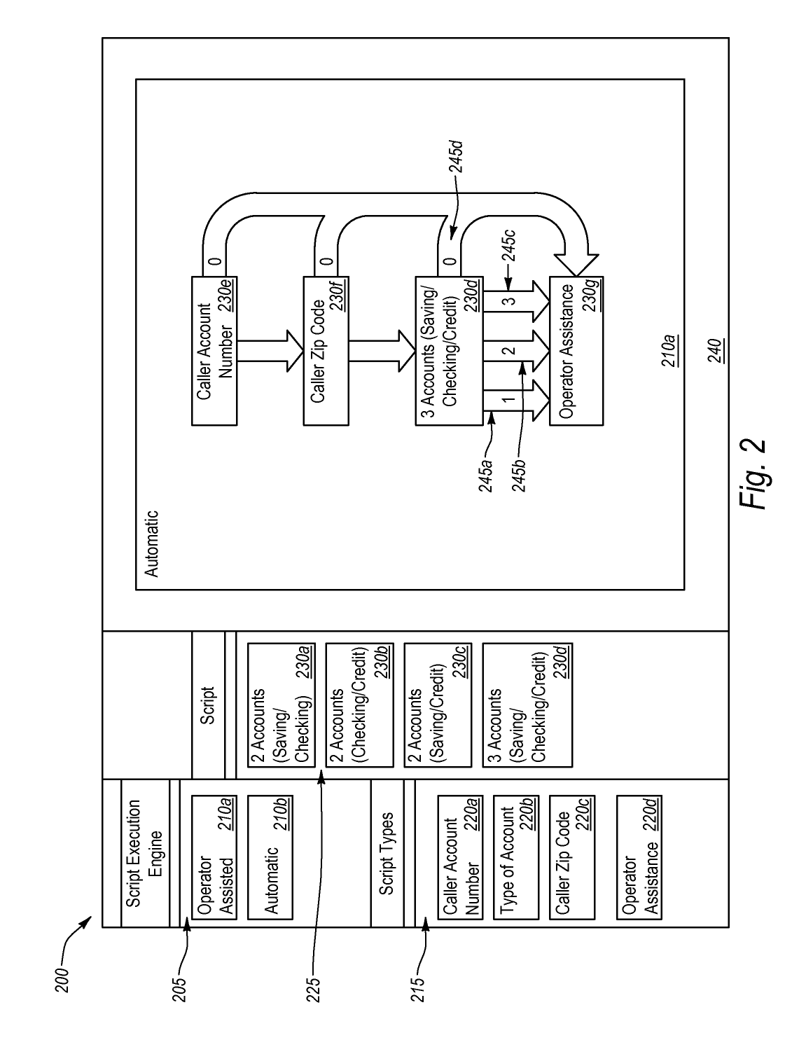

FIG. 2 illustrates a graphical user interface 200 that can be used to add scripts to a script execution engine in accordance with an implementation of the invention. In at least one implementation, the graphical user interface 200 (GUI) is a type of interface which allows a business to construct a script application with one or more scripts with images rather than text commands. In particular, the GUI 200 offers graphical icons, and visual indicators, as opposed to text-based interfaces, typed command labels or text navigation to fully represent the information and actions available to a script.

FIG. 2 shows that the GUI 200 includes a script application menu 205. In at least one implementation, the script application menu 205 includes different script applications 210a, 210b (collectively “script applications 210”) that a business can select from. In particular, the different script applications 210 can be configured to run different scripts. For example, the script application menu 205 can include a script application 210a that will run scripts that will instruct a business representative 112 to obtain the necessary information from a customer. Additionally or alternatively, the script application menu 205 can include a script application 210b that will run scripts that will automatically obtain the necessary information by playing a recorded message, a computer generated message or through some other method, asking a customer to enter information on his or her telephone keypad and saving the information to memory.

FIG. 2 also shows that the GUI 200 can include a script type menu 215 that includes different script types 220a, 220b, 220c, 220d (collectively “script types 220”). In at least one implementation, the different script types 220 can be organized by the general type of information requested. For example, FIG. 2 shows a script type menu 215 that includes script types 215 that request a customer's account number 220a, the type of account 220b, a customer's zip code 220c, and requests operator assistance for the customer 220d. Additionally or alternatively, the different script types 220 can be organized according to any desired criteria by the creator of the GUI 200.

FIG. 2 further shows that the GUI 200 can include a script menu 225 that includes different scripts 230a, 230b, 230c, 230d (collectively “scripts 230”). In at least one implementation, the different scripts 230 vary based on the number of options available to the customer. For example, the different scripts 230 can include scripts that vary according to the length of the information to be obtained, i.e., if the script type is a customer's account number 220a, different scripts 230 can be selected based upon different lengths of account numbers which the script 230 can receive. Additionally or alternatively, the different scripts can include scripts 230 which have different selections for a customer to choose from. For example, FIG. 2 shows scripts 230 in the script menu 225 which have different numbers of possible accounts and different account types, i.e., the script menu 225 includes a script 230a for if the account can include a savings account and a checking account, a script 230b for if the account can include a checking account and a credit card account, a script 230c for if the account can include a savings account and a credit card account and a script 230d for if the account can include a savings account, a checking account and a credit card account.

Additionally or alternatively, the scripts 230 can allow a customer to make a selection which can lead to further scripts, present the requested information to the customer, and connect the customer to a business representative 112 or perform some other action. In particular, the selection can be made by correlating specific options to specific numbers which the customer can select on his or her telephone keypad. For example, the script can include a message that says, “Select 1 for a savings account, select 2 for a checking account,” etc. Additionally or alternatively, the script can prompt the customer to verbalize the selection and use speech recognition software to determine the customer's selection.

FIG. 2 also shows that the GUI 200 includes an additional frame. In at least one implementation, the additional frame 240 can be used to add scripts to the script application. In particular, a script application 210 and appropriate scripts 230 can be assembled through direct manipulation of the graphical elements. For example, a business can drag and drop the desired script 210 to the additional frame. The business can then drag and drop appropriate scripts 230 from the scripts menu 225 to place in the script application.

In at least one implementation, as a business drags and drops scripts 230 into the script application, the script 230 can include additional graphical elements to help the business create a functional script application 210. For example, FIG. 2 shows that the script 230d includes four arrows 245a, 245b, 245c, 245d (collectively “arrows 245”) which shows the business the potential choices that can be made by the customer or possible alternatives from the script 230d.

Returning to FIG. 1, FIG. 1 also shows that the contact handling system 100 includes a per-action compiler 120. In at least one implementation, the per-action compiler 120 can allow scripts to be compiled when run for the first time. Additionally or alternatively, a per-action compiler 120 can allow two or more scripts to be compiled independent of one another, even if they are related to one another or work with one another.

FIG. 1 further shows that the contact handling system 100 includes a file server 125. In at least one implementation, the file server 125 can include a script database. A script database can include one or more scripts for use by the first computing environment 115a and the second computing environment 115b for communicating with the customer 110. The scripts in the script database can include compiled scripts and uncompiled scripts. For example, the script database can include scripts that have not been run previously, and thus have not been compiled by the per-action compiler.

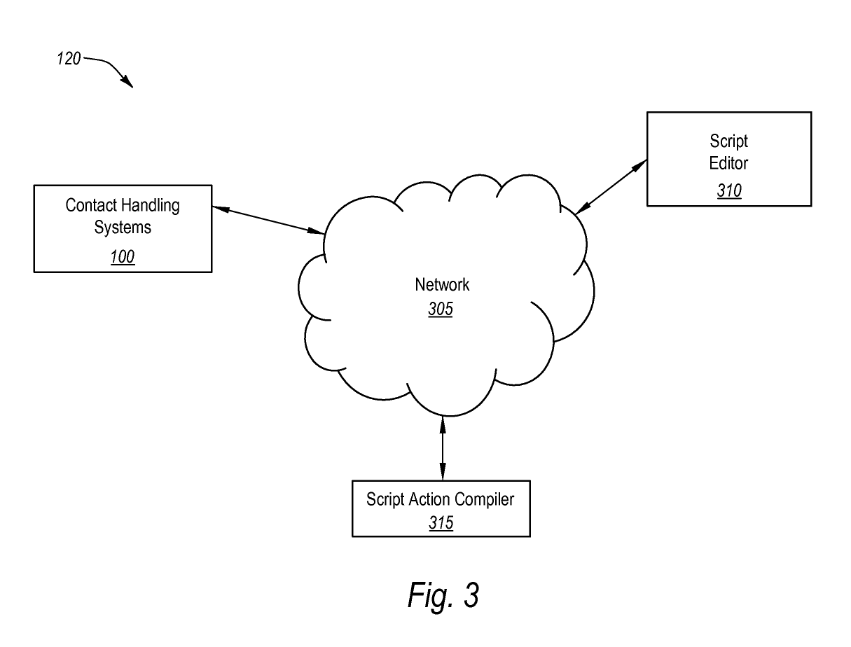

FIG. 3 illustrates a block diagram of a per-action compiler 120 in accordance with an embodiment. In at least one implementation, a per-action compiler 120 can allow scripts to be compiled as they are needed. Scripts include one or more actions to be accomplished by a script application. For example, the per-action compiler 120 can allow a particular script to be compiled only when run for the first time. Splitting up each script application into script actions can prevent a single script application from requiring too much memory or too many CPU cycles.

FIG. 3 shows that the per-action compiler includes a network 305. In at least one implementation, the network 305 allows data transfer from one element of the per-action compiler 120 to other elements of the per-action compiler 120. In particular, the network 305 can include any mechanism, apparatus or device for transferring data. For example, the network 305 can include a single computer, a group of interconnected computers or the Internet.

FIG. 3 shows that, in at least one implementation, the network 305 can connect to a script editor 310. Scripts can include a portion of a script application which can be accommodated to the needs of a particular business, as described below. For example, scripts can include actions to obtain certain information from a customer. Different business may need different information from customers. For example, a credit card business may need an account number in order to assist a customer. In contrast, a business such as a governmental agency may need a social security number to properly identify the customer before being able to proceed.

Scripts can be, although they need not be, written in the same programming language as the script application of which they are a part, or can be graphically represented as icons. For example, the script application can be written in C/C++ and the scripts can be created using JavaScript. One of ordinary skill in the art will appreciate that the script application and the scripts can be written in any appropriate language or assemblage of graphical objects, whether the same or different, and work with the per-action compiler 120. Creating the scripts apart from the script application can allow the scripts to be configured to the needs of the individual business, as described below.

In at least one implementation, a business is attempting to execute script applications in the contact handling system 100. For example, a business can include a client of a contact handling service provider for whom contact handling services are provided. Additionally or alternatively, an employee of a contact handling services provider can design a script application or script for the business. A business can execute script applications designed by the owner of the contact handling system 100, script applications designed by the business, third-party providers or script applications provided in any other manner.

FIG. 3 also shows that the network 305 is connected to a contact handling system 100, as described above. In at least one implementation, a contact handling system 100 can receive calls from a customer. For example, a contact handling system 100 can receive calls from a customer who wants to purchase a product or check an account balance.

FIG. 3 also shows that, in at least one implementation, the per-action compiler 120 can include a compiler 315. A compiler is a computer program, or set of programs, that transforms graphical representations or source code written in a computer language (the source language) into another computer language (the target language, often, but not always, having a binary form known as object code or machine code). In at least one implementation, the compiler 315 can compile each script action individually. For example, if a business changes a particular script in an existing script application, but leaves all other scripts unchanged, the compiler 315 can compile the changed script and forego compiling the unchanged scripts. Additionally or alternatively, the per-action compiler 120 can check each script when it is requested by the script application. If the script has been previously compiled, the per-action compiler 120 can use the previously compiled version of the script. If the script has been changed since it was last compiled, the per-action compiler 120 can send the script to the compiler 315, where a newly-compiled actions are generated. That is, the per-action compiler 120 can compile each script the first time the script is run, with subsequent uses referencing the previously compiled version of the script.

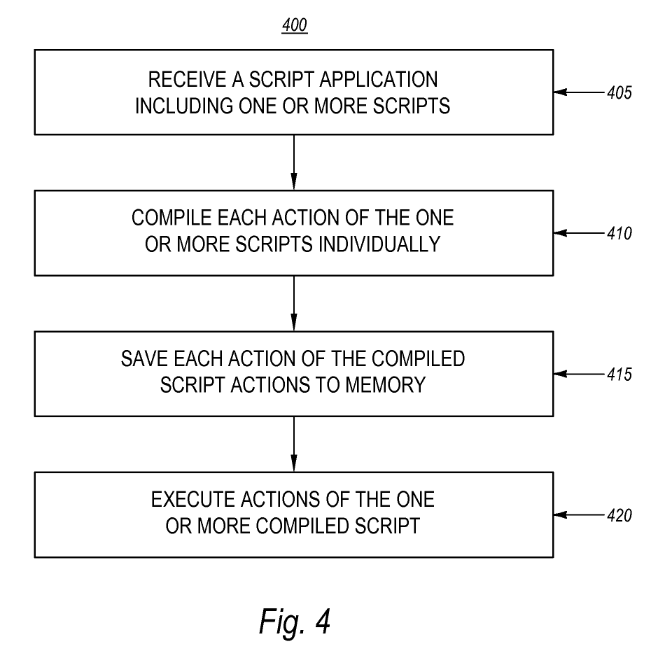

FIG. 4 is a flow diagram illustrating a method 400 for per-action compiling a script. Per-action compiling can allow the compilation to proceed more quickly. For example, per-action compiling of scripts can allow the script application to use the previously compiled scripts if the scripts are unchanged since their last use. Alternatively, per-action compiling of scripts can compile the scripts for use by the script application if the scripts have been changed since their last use. Accordingly, a script only needs to be compiled on the first use, save compiling time and hardware costs, since the number of compilations can be much lower than using other methods.

FIG. 4 shows that the method 400 includes receiving a script application including one or more scripts 405. In at least one implementation, receiving the script application including one or more scripts 405 can include receiving a data transmission that includes the script application and the one or more scripts. Additionally or alternatively, receiving the script application and one or more scripts can include retrieving the script application and one or more scripts from memory.

FIG. 4 further shows that, in at least one implementation, the method 400 further includes compiling each action of the one or more scripts individually 410. In at least one implementation, compiling each action of the one or more scripts individually 410 can allow the compiling to proceed quicker than compiling all of the scripts simultaneously. For example, compiling each action of the one or more scripts individually 410 can allow for each of the one or more scripts to be recompiled if changes are made to the script. In contrast, the remaining scripts of the one or more scripts in the script application need not be recompiled if no changes have been made to the remaining scripts of the one or more scripts. Accordingly, changes to individual scripts can be compiled quickly relative to systems in which all scripts are recompiled if any changes are made to any one of the one or more scripts.

In at least one implementation, compiling each action of the one or more scripts individually 410 can occur when each script is run for the first time. For example, if two scripts are provided for the script application, the first script can be compiled when it is first executed. During each subsequent execution of the first script the compiled version of the first script can be used for execution rather than the uncompiled version. Continuing the example, the second script can additionally be compiled when it is first executed. During each subsequent execution of the second script the compiled version of the second script can be used for execution rather than the uncompiled version. If changes are made to the second script and not to the first script, subsequent execution of the first script can use the original compiled version of the first script. In contrast, the second script can be compiled when the modified version of the second script is first executed with subsequent executions using the newly-compiled version of the second script.

FIG. 4 also shows that the method 400 further includes saving each of the one or more compiled script actions to memory 415. In at least one implementation, saving each of the one or more compiled script actions to memory 415 can allow the compiled scripts to be executed when changes have not been made to the original scripts. In particular, the retrieval of compiled scripts from memory for execution is faster than compilation of a script for execution.

FIG. 4 further shows that the method 400 includes executing the script application and at least one of the one or more compiled script actions 420. In at least one implementation, executing the script application and at least one of the one or more script actions 420 includes prompting a business representative 112 to obtain information from a customer. Additionally or alternatively, execution of the script can include playing a recorded message or computer-generated message asking a customer to enter information on his or her telephone keypad and saving the information to memory.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

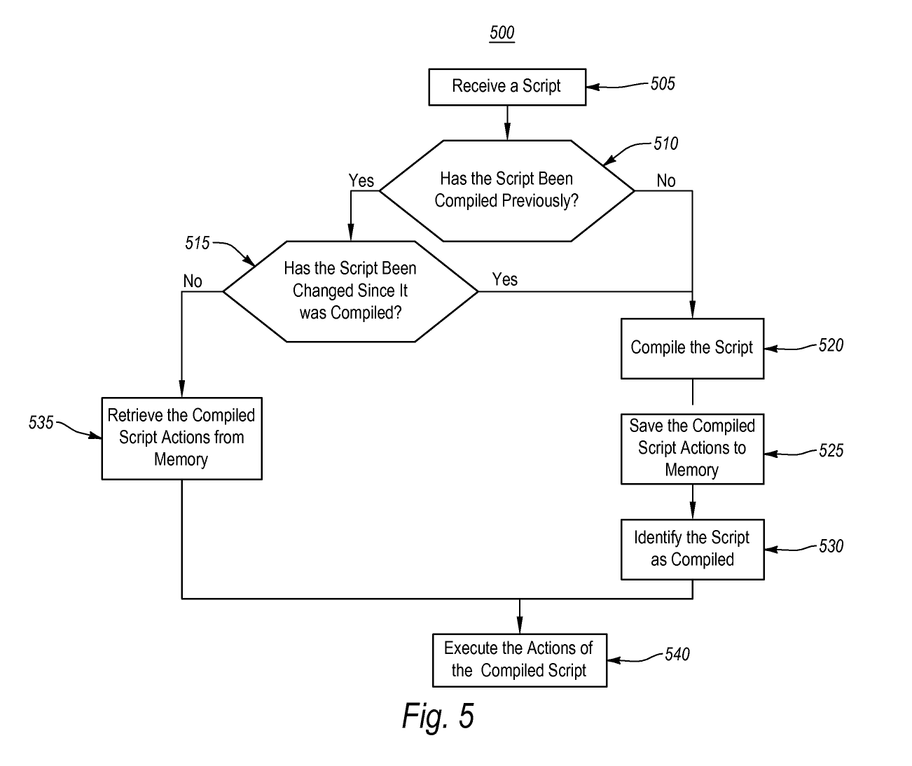

FIG. 5 is a flow diagram illustrating an alternative method 500 for per-action compiling a script. In at least one implementation, per-action compiling a script can compile the script the first time that the script is executed. In subsequent executions the compiled script can be retrieved from memory. Accordingly, resources are not used on compiling the script until execution is requested. Additionally, resources are conserved because each script is only compiled one time.

FIG. 5 shows that, in at least one implementation, the method 500 includes receiving a script 505. Receiving the script 505 can occur prior to any execution of the script. Additionally or alternatively, receiving the script can occur at the time of execution of the script. In at least one implementation, receiving a script 505 includes receiving identifying information for the script. For example, scripts can be identified with unique titles or numerical identifiers. In such cases, the entire text of the script need not be received; instead the identifying information may be received.

FIG. 5 also shows that the method 500 includes determining whether the script has been compiled previously 510. In at least one implementation the identifying information of the script can be used to determine whether the script has been previously compiled 510. For example, a table, or any other acceptable data structure, can be used to look up the identifying information and determine whether the script has been previously compiled 510. In at least one implementation, the table can include information regarding whether the script was compiled, when the script was compiled, and whether changes have been made to the script since it was last compiled.

Additionally or alternatively, a list can be consulted to determine whether the script has been previously compiled. For example, a list can be maintained of all scripts which have been compiled. Additionally or alternatively, each script can include a header which indicates whether the script has been compiled.

FIG. 5 further shows that if the script has been compiled before, the method includes determining if the script has been changed since it was compiled 515. In at least one implementation, the identifying information of the script can be used to determine whether the script has been changed since it was compiled 515. For example, a table, or any other acceptable data structure, can be used to look up the identifying information and determine whether the script has been changed since it was compiled 515. Additionally or alternatively, a list, or other data structure, can be used to maintain a list of scripts that have been changed since they have been compiled, or the script can include a header which indicates whether the script has been changed since it was compiled.

It is understood that although the method 500 of FIG. 5 shows determining whether the script has been previously compiled 510 and determining whether the script has been changed since it was compiled 515 as distinct steps, the two determinations can be made simultaneously. For example, a table, a list or a script header, can be maintained with a single variable which identifies whether the script has been compiled in its current form.

FIG. 5 also shows that the method 500 includes compiling the script 520 if the script has not been previously compiled or if the script has changed since it was last compiled. In at least one implementation, compiling the script 520 includes transforming source code written in a computer language into another computer language. For example, compiling the script 520 can include transforming the script from a language, such as Java or C, to a language that can be executed by a processor or other device, such as machine code. In another implementation, compiling the script 520 includes transforming graphical representations into computer-executable form.

FIG. 5 further shows that the method includes saving the compiled script to memory 525. In at least one implementation, saving the compiled script to memory 525 can allow the compiled script to be retrieved and executed when changes have not been made to the original script. In at least one implementation, memory can include computer data storage, random access memory (RAM), computer components, devices, and recording media that retain digital data, optical discs, magnetic storage, such as hard disk drives, or any other device for storage of data.

FIG. 5 also shows that the method 500 includes identifying the script as compiled 530. In at least one implementation, identifying the script as compiled 530 can allow future executions of the script to proceed with retrieval of the compiled script from memory rather than retrieval of the uncompiled script from memory and compilation of the script. In particular, identifying the script as compiled 530 can include updating a table, a list or a header.

FIG. 5 further shows that the method 500 includes retrieving the compiled script from memory 535 if the script has been compiled previously and if the script has not changed since it was last compiled. In at least one implementation, retrieving the compiled script from memory 535 can proceed more quickly than compiling the script. Accordingly, the script can be presented for execution more quickly by retrieving the compiled script from memory 535.

FIG. 5 also shows that the method 500 includes executing the actions of the compiled script 540. In at least one implementation, executing the actions of the compiled script 540 can be performed in a processor, an FPGA or other logic device. Execution of the actions of the compiled script 540 can include prompting a business representative 112 to obtain information from a customer. Additionally or alternatively, execution of the script can include playing a recorded message or computer generated message asking a customer to enter information on his or her telephone keypad and saving the information to memory.

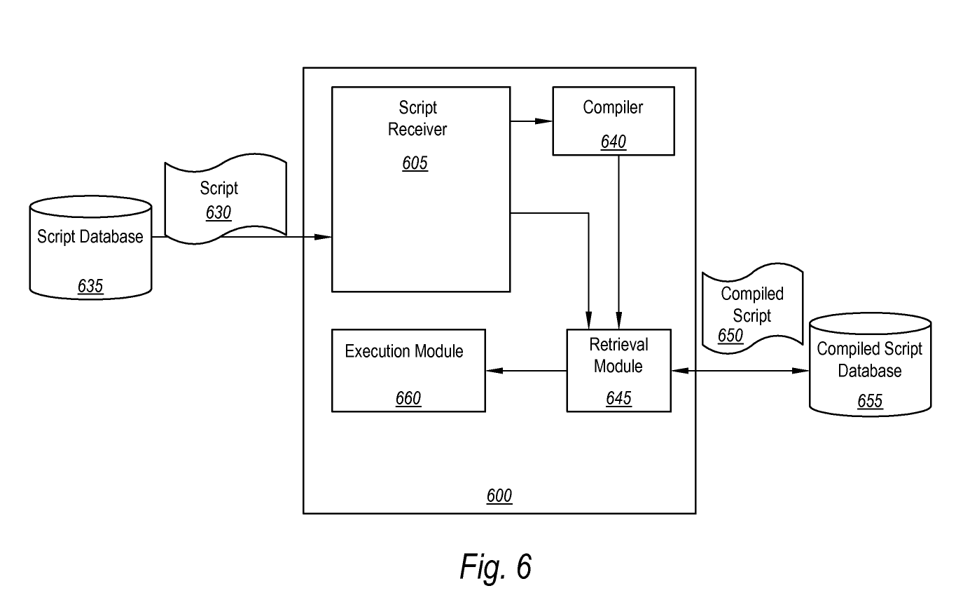

FIG. 6 illustrates an example of a system 600 for per-action compiling a script in accordance with an embodiment of the invention. The system 600 can be implemented in hardware, software or any combination thereof. If the system 600 is implemented in software, the modules of the system 600 are stored in a computer-readable medium, to be accessed as needed to perform their functions. Additionally, if the system 600 is implemented in software, the actions assigned to each module can be carried out by a processor, field-programmable gate array (FPGA) or any other logic device capable of carrying out software instructions or other logic functions.

It is understood that although the system 600 of FIG. 6 illustrates different modules performing different functions, the number of modules and their function can be changed without departing from the spirit or essential characteristics of the invention. That is, the functions of the modules may be combined or separated without restriction and without departing from the inventive concept presented herein.

FIG. 6 shows that the system 600 includes a script receiver 605. In at least one implementation, the script receiver 605 is configured to receive one or more scripts 630. FIG. 6 shows that the scripts 630 can be retrieved from a script database 635. Additionally or alternatively, the script receiver 605 can be co configured to receive the scripts 630 within a script application. Although shown as an external database, the script database 635 need not be external to the system 600 but can be integrated within the system 600. The one or more scripts 630 each include one or more actions to be accomplished by a script application. For example, the scripts 630 can include one or more pieces of information to be obtained from a customer. In at least one implementation, the information is obtained by prompting a business representative 112 to obtain the information from the customer. Additionally or alternatively, the information can be obtained automatically by having a customer enter the information on his or her telephone keypad.

FIG. 6 further shows that the system 600 includes a compiler 640. In at least one implementation, the compiler 640 is configured to compile each of the one or more scripts 630 individually. Each script 630 is compiled individually to allow for faster compiling when changes are made to individual scripts, as described above. Compiling each of the one or more scripts 630 individually can include translating the script from source code to machine code or other executable code.

FIG. 6 also shows that the system 600 includes a retrieval module 645. In at least one implementation, the retrieval module 645 can be configured to retrieve and save compiled scripts from a compiled script database 655. Although shown as an external database, the compiled script database 655 need not be external to the system 600 but can be integrated within the system 600. In at least one implementation, if a script 630 has not been previously compiled, the uncompiled script is passed to the compiler 640 where it is compiled. The compiled script 650 is then passed to the retrieval module 645 where it is saved to the compiled scripts database 655. Saving the compiled script 650 to the compiled scripts database 655 can allow for later retrieval of the compiled script 650, allowing for faster execution.

Additionally or alternatively, if the script 630 has been previously compiled the receiver 605 can pass the request directly to the retrieval module 645. The retrieval module 645 can then retrieve the compiled script 650 from the compiled script database 655. Therefore, retrieval of the uncompiled script 630 and compiling of the uncompiled script 630, both of which can be time-consuming processes, can potentially be avoided. Accordingly, the script can be executed more quickly.

FIG. 6 also shows that the system 600 includes an execution module 660. In at least one implementation, the execution module 660 is configured to execute at least one of the one or more compiled scripts 650. In at least one implementation, execution of the compiled script 650 includes prompting a business representative 112 to obtain information from a customer. Additionally or alternatively, execution of the script can include playing a recorded message or computer generated message asking a customer to enter information on his or her telephone keypad and saving the information to memory. In at least one implementation, the execution module 660 can include a processor, field-programmable gate array (FPGA) or any other logic device capable of carrying out software instructions or other logic functions.

### III. Multi-Tenancy

Returning to FIG. 1, FIG. 1 further shows that the contact handling system 100 includes a first computing environment 115a and a second computing environment 115b. In at least one implementation, the computing environments 115 can allow for communication between the contact handling system 100 and the customer 110 over the network 105. For example, the first computing environment 115a and second computing environment 115b can include one or more recorded messages which prompt the customer 110 to provide information. Additionally or alternatively, the computing environment 115 can allow a business representative 112 to speak directly to the customer 110 and prompt the business representative 112 for needed information or provide the business representative 112 with information which the business representative 112 can, in turn, provide to the customer.

In at least one implementation, a computing environment 115 includes any system, device or apparatus for manipulating data or following a set of instructions. For example, a computing environment 115 can include hardware such as processors, memory, display devices or any other elements for carrying out the computing environment's 115 functions, as described below. Additionally or alternatively, a computing environment 115 can include software for manipulating data or carrying out processes in hardware.

FIG. 1 also shows that one or more businesses 130a, 130b (collectively “businesses 130”) can make changes to the file server 125. In at least one implementation, the contact handling system 100 is capable of providing multi-tenancy for the scripts of the different businesses 130. Multi-tenancy can allow multiple businesses 130 to use the same computing environment 115 while preventing the first business 130a from excluding the second business 130b from the computing environment 115.

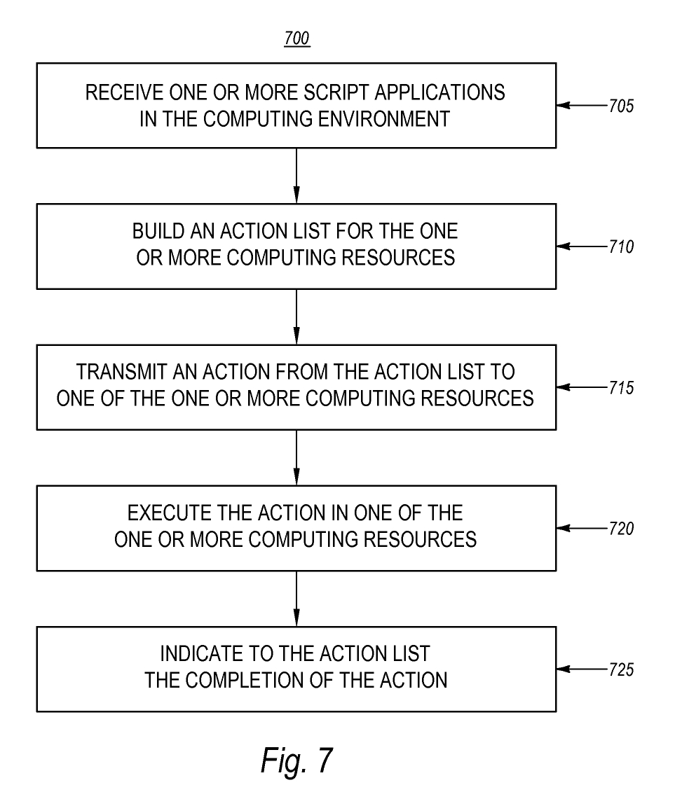

FIG. 7 is a flow diagram illustrating a method 700 for providing multi-tenancy in a computing environment. In at least one implementation, multi-tenancy includes multiple businesses using a single computing environment. For example, multi-tenancy can include different script applications for different businesses that are seeking processing resources.

FIG. 7 shows that, in at least one implementation, the method 700 includes receiving one or more script applications from one or more businesses in the computing environment 705. In at least one implementation, receiving one or more script applications in the computing environment 705 can include receiving identifying information for the one or more script applications. For example, the identifying information can include the name of the script or the memory address of the script.

FIG. 7 further shows that the method 700 includes building an action list for the one or more computing resources 710. In at least one implementation, the action list is a data structure that contains a list of one or more actions to be executed by the one or more computing resources. The action list can include actions from scripts from one or more businesses. Additionally or alternatively, the action list can include the order in which the actions are to be executed. In at least one implementation, the action list can include a first in first out (FIFO) data structure. The earlier an action is entered into a FIFO data structure the earlier the action will be executed. That is, an action which is in the FIFO data structure will be executed before actions which subsequently enter the FIFO data structure. Additionally or alternatively, the action list can include a last in first out (LIFO) data structure. The earlier an action is entered into a LIFO data structure the later the action will be executed. That is, an action which is in the LIFO data structure will be executed after actions which subsequently enter the LIFO data structure. Additionally or alternatively, the action list can include any data structure configured to retain actions to be performed by the computing resource and output the action to the computing resource in the proper order such as a queue, a stack or an array.

FIG. 7 also shows that the method 700 includes transmitting an action from the action list to one of the one or more computing resources 715. In at least one implementation, transmission can occur through any appropriate means of data transmission. For example, transmission can occur over optical lines, electric lines, buses or any other means of data transmission. Additionally or alternatively, transmission can include placing the action within a cache in the computing environment.

FIG. 7 further shows that the method 700 includes executing the action in one of the one or more computing resources 720. In at least one implementation, executing the action in one of the one or more computing resources 720 includes completing a series of commands in the computing resource. For example, the commands can include machine code which is directly executed by the computing resource.

FIG. 7 also shows that the method 700 includes indicating to the action list the completion of the action 725. In at least one implementation, indicating to the action list the completion of the first action 725 allows the action list to transmit further actions to the one or more computing resources for execution. Accordingly, the computing resources can be used effectively by script applications from multiple businesses. In particular, by allowing a script which is communicating with a customer to place only one action within the action list, a single script is prevented from using a computing resource to the exclusion of other scripts, and therefore one business is prevented from excluding other businesses from computing resources.

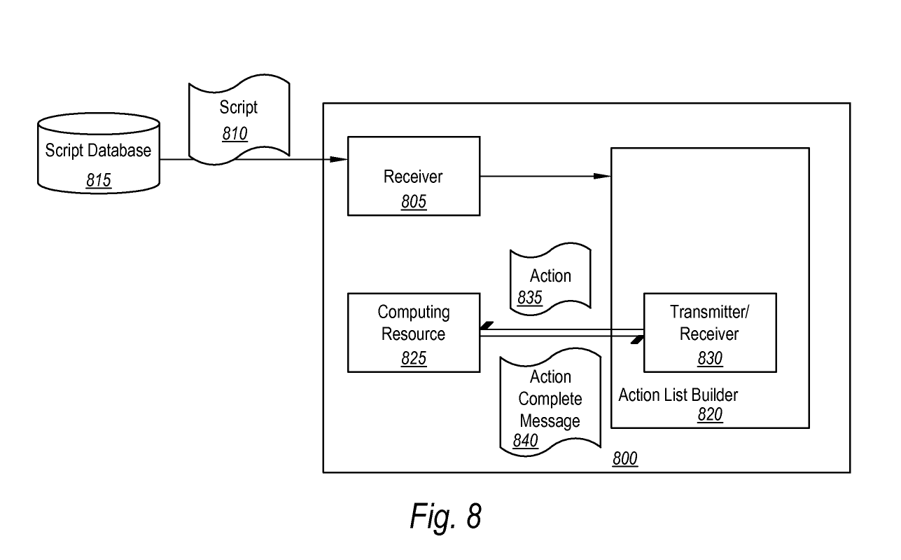

FIG. 8 illustrates an example of a system 800 for providing multi-tenancy in a computing environment in accordance with an embodiment of the invention. In at least one implementation, multi-tenancy allows the system to execute software from multiple companies without the different companies interfering with one another. Accordingly, each business does not need dedicated computing resources.

The system 800 can be implemented in hardware, software or any combination thereof. If the system 800 is implemented in software, the modules of the system 800 are stored in a computer-readable medium, to be accessed as needed to perform their functions. Additionally, if the system 800 is implemented in software, the actions assigned to each module can be carried out by a processor, FPGA or any other logic device capable of carrying out software instructions or other logic functions.

It is understood that although the system 800 of FIG. 8 illustrates different modules performing different functions, the number of modules and their function can be changed without departing from the spirit or essential characteristics of the invention. That is, the functions of the modules may be combined or separated without restriction and without departing from the inventive concept presented herein.

FIG. 8 shows that the system 800 includes a receiver module 805. In at least one implementation, the receiver module 805 is configured to receive a script 810. FIG. 8 shows that the script 810 can be retrieved from a script database 815. Although shown as an external database, the script database 815 need not be external to the system 800 but can be integrated within the system 800. The script is configured to execute one or more actions, as described below. In at least one implementation, the script 810 can be compiled upon the script's first execution, as described above.

FIG. 8 also shows that the system 800 includes an action list builder 820 that is configured to build an action list. In at least one implementation, the action list can include a data structure that contains one or more actions from one or more businesses to be executed by one or more computing resources 825. Additionally or alternatively, the action list can include the order in which the actions are to be executed. For example, the action list can include a first in FIFO data structure or a LIFO data structure, such as a queue, a stack, an array or another data structure.

FIG. 8 further shows that the action list builder 820 includes a transmitter/receiver module 830. In at least one implementation, the transmitter/receiver module 830 is configured to transmit an action 835 from the action list to the one or more computing resources 825. In at least one implementation, transmission and reception can occur through any appropriate means of data transmission. For example, transmission and reception can occur over optical lines, electric lines, buses or any other means of data transmission. Additionally or alternatively, transmission can include placing the action within a cache in the one or more computing resources 825 and reception can include receiving the action from a cache in the one or more computing resources 825.

In at least one implementation, the one or more computing resources 825 are configured to execute the action 835. A computing resource, or system resource, is any physical or virtual component of limited availability within a computing environment. For example, the one or more computing resources 825 can include processors, CPU time, random access memory, virtual memory, hard disk space, network throughput, electrical power, external devices or any other physical or virtual component, as described above.

FIG. 8 further shows that the one or more computer resources 825, by sending an action complete message 840, indicate to the action list builder 820 the completion of the action. In at least one implementation, the one or more computer resources 825 send the action complete message 840 by acknowledging receipt of the action. That is, the action list assumes that the action is completed by the one or more computer resources 825 once the action is received by the one or more computing resources 825. Additionally or alternatively, the action list can transmit the action complete message 840 to the action list builder 820 after the completion of the action.

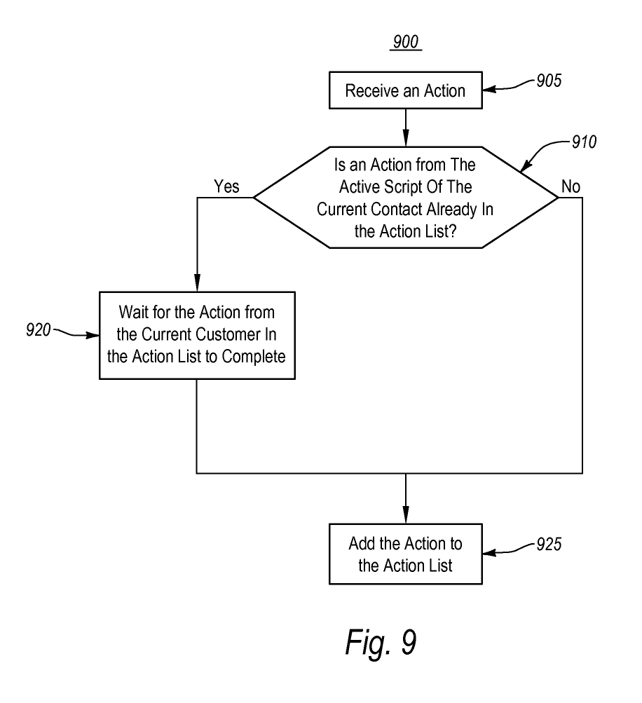

FIG. 9 is a flow diagram illustrating a method 900 for building an action list in a multi-tenant environment in accordance with an embodiment. In at least one implementation, the action list can include a data structure that contains a list of one or more actions from one or more businesses to be executed by the one or more computing resources. Additionally or alternatively, the action list can include the order in which the actions are to be executed. In at least one implementation, the action list can include a FIFO data structure or a LIFO data structure, such as a queue, a stack, an array or any other data structure.

FIG. 9 shows that the method 900 can include receiving an action 905. In at least one implementation, receiving an action 905 includes receiving a script. Receiving an action 905 can include receiving identifying information of the action. For example, receiving an action 905 can include receiving the name of the action. Additionally or alternatively, receiving a action 905 can include receiving the memory address of the action.

FIG. 9 also shows that the method 900 includes determining if an action from the active script of the current contact is already in the action list 910. In at least one implementation, determining whether the action list contains an action from the current customer is already in the action list 910 can be done by searching the action list for actions from the current customer. Additionally or alternatively, a table or other data structure can be used to maintain a list of contacts with actions in the action list. Accordingly, determining if an action from the current customer is already in the action list 910 can include searching the table for the contact.

FIG. 9 also shows that the method 900 includes waiting for the action from the current customer in the action list to complete 920. In at least one implementation, waiting for the action from the current customer in the action list to complete 920 can ensure that each script can only have one action in the action list. Accordingly, the computing resources can be allocated among different contacts, without preventing access to any business or customer.

FIG. 9 further shows that the method 900 includes adding the action to the action list 925 if there is not an action from the current customer already in the action list or if an action from the current customer has been completed and the current customer has an action in the buffer. In at least one implementation, each script can be allocated one spot in the action list to ensure that each business has proportional access to computing resources. For example, multiple account holders at a bank can each be allocated one spot in the action list, despite the fact that each can use the same script application from the same business to obtain information. Accordingly, a single business or customer is prevented from monopolizing the computing resources.

IV. Redundancy using Check Pointing and Snapshots

Returning to FIG. 1, FIG. 1 further shows that the first computing environment 115a and the second computing environment 115b are in communication with one another. In particular, the first computing environment 115a communicates with the customer 110 and the second computing environment 115b allows for the communication between the contact handling system 110 and the customer 110 to be maintained if failure occurs in the first computing environment 115a. In at least one implementation, the second computing environment 115b can allow the customer 110 to continue the contact without starting from the beginning again, through snapshots and check-pointing.

In at least one implementation, check-pointing includes discrete time intervals or discrete points in a program where information is saved. For example, checkpoints can be inserted at the end of a script, such that when a script is complete, the state will be saved. Additionally or alternatively, checkpoints can be taken after certain information has been obtained or when waiting for necessary computing resources are available.

In at least one implementation, a snapshot includes a record of the state of a script within contact handling system 100. In particular, a state is a unique configuration of information in a program or machine. For example, a snapshot can include the value of all variables within a script application, a script or any other action. Additionally or alternatively, a snapshot can include which scripts have been run, which script is currently running, and which scripts need to be run. Snapshots can be used by a server or computing environment to restart or resume the execution of a script application or script in the case of execution failure.

In at least one implementation, the contact handling system 100 includes a first computing environment 115a for executing the script application and the associated scripts and a second computing environment 115b for taking over execution of the script application and the associated scripts in the case of a failure in the first computing environment 115a. Accordingly, execution of the script application and the associated scripts can proceed in the event of a failure. In voice communication systems, redundancy can ensure that the voice communication is not lost due to a partial system failure.

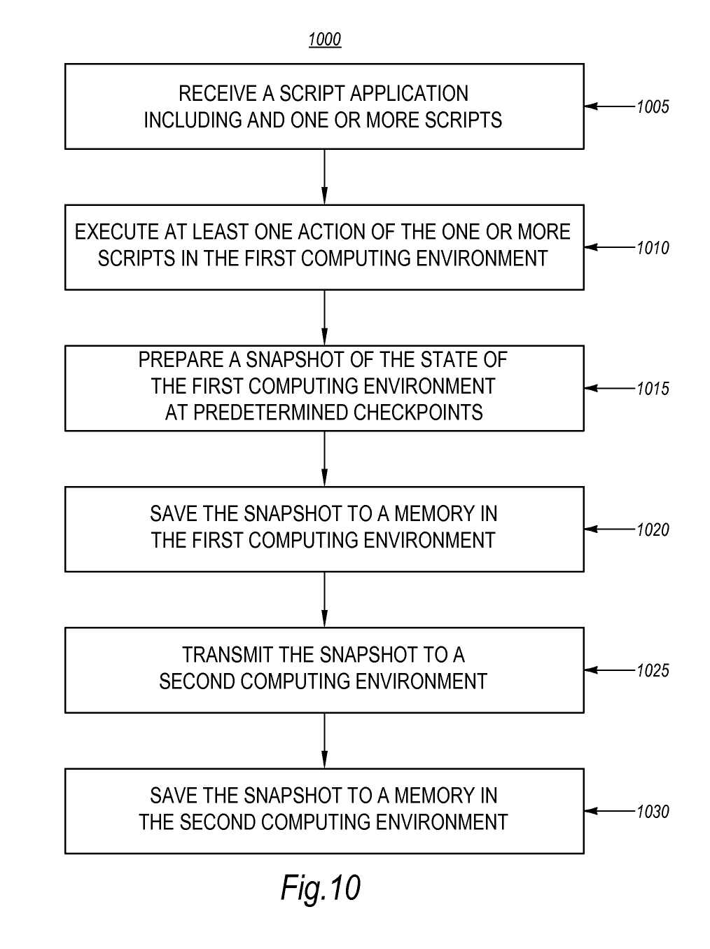

FIG. 10 is a flow diagram illustrating a method 1000 for providing redundancy using checkpointing and snapshots. In particular, the method 1000 can ensure that a contact handling system maintains a connection with a customer, even in the event of a partial failure. For example, if a customer has put in some or all of their identifying information and their call is dropped, they might not call back and sales or accounts can be lost. Accordingly, redundancy in the contact handling systems hardware and in storing contact information can provide an advantage to companies that provide contact handling services.

Redundancy can be provided in multiple computing environments data storage in two general methods. The information can be transmitted in whole. I.e. the value of every variable can be saved to both computing environments. This provides the benefit of ensuring that the data saved in both computing environments is as close to one another as possible. In particular, lost messages or errors in messages to one of the computing environments does not affect the accuracy of the information in that computing environment after the arrival of subsequent messages, since each subsequent message contains information regarding all of the variables. However, the amount of data can be large, depending on the nature and number of variables involved.

Additionally or alternatively, information regarding changes to the particular variables can be transmitted to both computing environments, i.e., only the new value of changed variables is transmitted. This method allows for easy updates since, in general, most variables are not updated continuously. However, if an update is lost or errors are introduced the two data saved in the two computing environments may not reflect one another. For example, if an update to the second environment is lost, the second computing environment will contain errors in the variables updated until a subsequent message arrives which updates those variables.

FIG. 10 shows that the method 1000 includes receiving a script application including one or more scripts 1005. In at least one implementation, receiving a script application including one or more scripts 1005 includes receiving a script application including one or more scripts 1005 in a first computing environment and in a second computing environment. In at least one implementation, receiving a script application including one or more scripts 1005 receiving identifying information for the script application and the one or more scripts. For example, the name or memory address of the script application and one or more scripts can be received rather than the actual script.

FIG. 10 further shows that the method 1000 includes executing at least one action of the one or more scripts in the first computing environment 1010. In at least one implementation, executing at least one action of the one or more scripts in the first computing environment 1010 includes executing the at least one action within a script execution engine. In at least one implementation, executing at least one action of the one or more scripts in the first computing environment 1010 includes prompting a business representative 112 to obtain information from a customer. Additionally or alternatively, executing at least one action of the one or more scripts in the first computing environment 1010 can include playing a recorded message or computer generated message asking a customer to enter information on his or her telephone keypad and saving the information to memory, as described above.

FIG. 10 also shows that the method 1000 includes preparing a snapshot of the state of the first computing environment at predetermined checkpoints 1015. In at least one implementation, the snapshot can include information regarding the variables in the script application and the script. For example, the snapshot can include the number, type and value of the variables in a script being run. Additionally or alternatively, the snapshot can include information regarding the script application or the script being run. For example, the snapshot can include the script being run and the location in the script where the snapshot was taken.

In at least one implementation, the predetermined checkpoints can be at specific points in the script application and the one or more scripts. For example, the snapshot can be prepared at the beginning or the end of each script. Additionally or alternatively, the predetermined checkpoints can be whenever information is obtained from a customer. For example, a snapshot can be taken after the customer inputs information regarding an account number.

Additionally or alternatively, predetermined checkpoints can occur when certain thresholds are met in the computing environment. For example, predetermined checkpoints can be set for when CPU usage falls below a certain threshold. In at least one implementation, setting predetermined checkpoints for when CPU usage falls below a certain threshold can ensure that the CPU is available to produce the snapshot. Additionally or alternatively, predetermined checkpoints can be scheduled when network resources are available for transmission of the snapshot, as discussed below.

FIG. 10 also shows that the method 1000 includes saving the snapshot to memory in the first computing environment 1020. In at least one implementation, memory can include computer data storage, random access memory (RAM), computer components, devices, and recording media that retain digital data, optical discs, magnetic storage, such as hard disk drives, or any other device for storage of data.

In at least one implementation, saving the snapshot to memory in the first computing environment can allow the first computing environment to recover in the event of an error. Additionally or alternatively, saving the snapshot to memory in the first computing environment can allow for retrieval of additional information needed by the script. For example, if a customer has input an account number, saving the snapshot to memory can allow the computing environment to look-up the customer's account balance.

FIG. 10 further shows that the method 1000 includes transmitting the snapshot to a second computing environment 1025. In at least one implementation, transmission can occur through any appropriate means of data transmission. For example, transmission can occur over optical lines, electric lines, buses or any other means of data transmission. Additionally or alternatively, transmission can include placing the snapshot directly within a cache in the second computing environment.

In at least one implementation, the second computing environment is available to run the script application and the one or more scripts if a failure occurs in the first computing environment. For example, the second computing environment can contain hardware that is identical to the hardware in the first computing environment. Additionally or alternatively, the second computing environment can contain hardware that is different than the hardware in the first computing environment but that is, nevertheless, capable of executing the script application and the one or more scripts.

FIG. 10 also shows that the method 1000 includes saving the snapshot to a memory in the second computing environment 1030. In at least one implementation, saving the snapshot to a memory in the second computing environment 1030 can allow the second computing environment to resume execution of the script application and the one or more scripts from the last checkpoint if a failure occurs in the first computing environment.

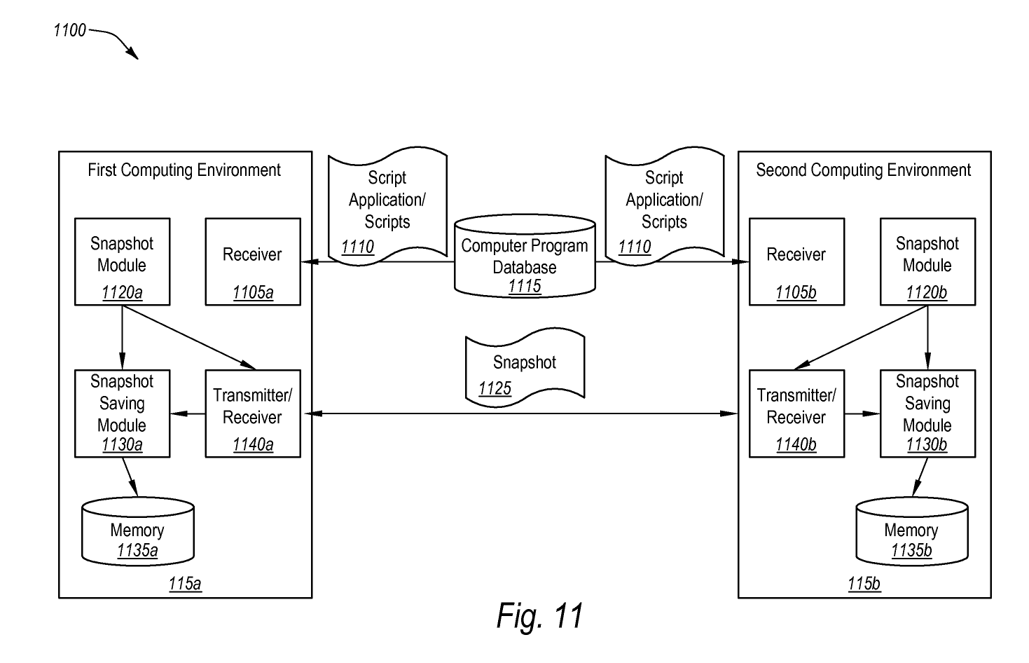

FIG. 11 illustrates an example of a system 1100 for providing redundancy using check pointing and snapshots. The system 1100 can be implemented in hardware, software or any combination thereof. If the system 1100 is implemented in software, the modules of the system 1100 are stored in a computer-readable medium, to be accessed as needed to perform their functions. Additionally, if the system 1100 is implemented in software, the actions assigned to each module can be carried out by a processor, FPGA or any other logic device capable of carrying out software instructions or other logic functions.

It is understood that although the system 1100 of FIG. 11 illustrates different modules performing different functions, the number of modules and their function can be changed without departing from the spirit or essential characteristics of the invention. That is, the functions of the modules may be combined or separated without restriction and without departing from the inventive concept presented herein.

FIG. 11 shows that the system 1100 includes a first computing environment 115a and a second computing environment 115b. However, the system can include more than two computing environments 115. In at least one implementation, a computing environment 115 includes any system, device or apparatus for manipulating data or following a set of instructions. For example, a computing environment 115 can include hardware such as processors, memory, display devices or any other elements for carrying out the computing environments functions, as described above. Additionally or alternatively, a computing environment 115 can include software for manipulating data or carrying out processes in hardware.

In at least one implementation, the second computing environment 115b is available to run the script application and the one or more scripts if a failure occurs in the first computing environment 115a. For example, the second computing environment 115b can contain hardware that is identical to the hardware in the first computing environment 115a. Additionally or alternatively, the second computing environment 115b can contain hardware that is different than the hardware in the first computing environment 115a but that is, nevertheless, capable of executing the script application and the one or more scripts.

FIG. 11 also shows that the first computing environment 115a and second computing environment 115b include a receiving module 1105a, 1105b (collectively “receiving module 1105”). In at least one implementation, the receiving module 1105 can be used to receive a script application and one or more scripts 1110. For example, the receiving module 1105 can receive the script application and the one or more scripts 1110 from a program database. In at least one implementation, the first computing environment 115a and second computing environment 115b can receive the script application and the one or more scripts 1110 independent of one another. For example, the script application and the one or more scripts 1110 can be transmitted to the first computing environment 115a and the second computing environment 115b simultaneously. Additionally or alternatively, the first computing environment 115a prior to execution can receive the script application and the one or more scripts 1110 and the second computing environment 115b can receive the script application and the one or more scripts 1110 only in the event of a failure of the first computing environment 115a.

FIG. 11 further shows that the first computing environment 115a and second computing environment 115b respectively includes a first snapshot module 1120a and second snapshot module 1120b (collectively “snapshot module 1120”). In at least one implementation, the snapshot module 1120 is configured to prepare a snapshot 1125 of the state of the computing environment at predetermined checkpoints in the script application and the one or more scripts 1110. In at least one implementation, a snapshot 1125 includes a record of the state of the system. In particular, a state is a unique configuration of information in a program or machine. For example, a snapshot can include the value of all variables within the script application, a script or any other important data. Additionally or alternatively, a snapshot 1125 can include which scripts have been run, which script is currently running, and which scripts need to be run. Snapshot 1125 can be used by a computing environment 115 to restart or resume the execution of a script application or script in the case of execution failure.

FIG. 11 also shows that the first computing environment 115a and second computing environment 115b respectively include a first snapshot saving module 1130a and a second snapshot saving module 1130b (collectively “snapshot saving module 1130”). In at least one implementation, the snapshot saving module 1130 can save the snapshot 1125 to a first memory 1135a or second memory 1135b in the first computing environment 115a and the second computing environment 115b respectively. In at least one implementation, memory can include computer data storage, random access memory (RAM), computer components, devices, and recording media that retain digital data, optical discs, magnetic storage, such as hard disk drives, or any other device for storage of data.

FIG. 11 further shows that the first computing environment 115a and second computing environment 115b respectively include a first transmitter/receiver 1140a and a second transmitter/receiver 1140b (collectively “transmitter/receiver 1140”). In at least one implementation, the transmitter/receiver 1140 can transmit the snapshot 1125 in the first computing environment 115a from the second computing environment 115b and vice versa. In at least one implementation, transmission and reception can occur through any appropriate means of data transmission. For example, transmission and reception can occur over optical lines, electric lines, buses or any other means of data transmission.

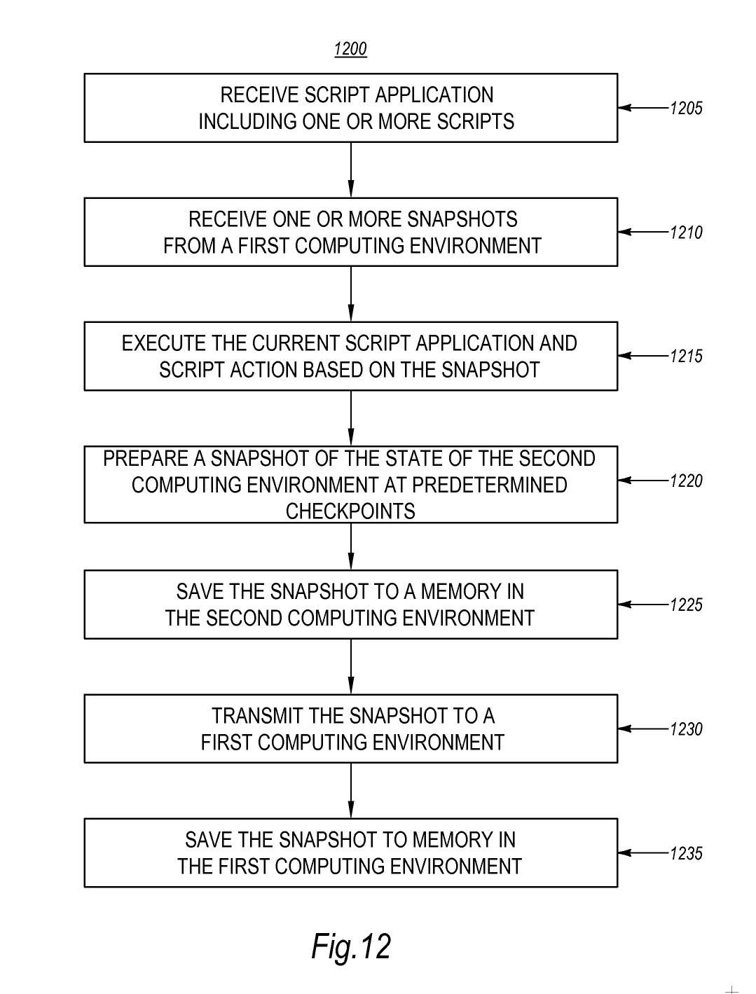

FIG. 12 is a flow diagram illustrating a method 1200 for executing a script in a second computing environment if a failure occurs in a first computing environment. In at least one execution, a second computing environment is used to execute a script application and one or more scripts if a first computing environment is unable to continue the execution of the script application and one or more scripts.

FIG. 12 shows that the method 1200 includes receiving a script application including one or more scripts 1205 in the second computing environment. In at least one implementation, receiving the script application including one or more scripts 1205 can occur when the script application and one or more scripts is received in the first computing environment. In particular, receiving the script application including one or more scripts 1205 can be provided to the first computing environment and the second computing environment before any execution occurs in either the first computing environment or the second computing environment. Additionally or alternatively, receiving the script application including one or more scripts 1205 the second computing environment can occur only after the one first computing environment has experienced a failure.

FIG. 12 also shows that the method 1200 includes receiving one or more snapshots 1210 from the first computing environment. In at least one implementation, the snapshots from the first computing environment include a record of the state of the first computing environment, as described above. In particular, the one or more snapshots from the first computing environment can include which scripts have been executed, which script is currently being executed and the values of all variables in the script.

FIG. 12 further shows that the method 1200 includes executing the current script application and script action based on the snapshot 1215 when the first computing environment experiences a failure. In at least one implementation, the second computing environment can begin executing the current script at the beginning of the script. Executing the current script from the beginning of the script can mean that the customer hears the same message more than once but that communication with the customer is not lost. Nevertheless, executing the current script from the beginning of the script might not introduce any noticeable error to the customer if the customer is speaking to a business representative 112 or if the failure occurs before the script prompts the customer for information.

FIG. 12 also shows that the method 1200 includes preparing a snapshot of the state of the second computing environment at predetermined checkpoints 1220 in the execution of the script application and the one or more scripts. In at least one implementation, the snapshot can include information regarding the variables in the script application and the script, as described above. Additionally or alternatively, the predetermined checkpoints can be at specific points in the script application and the one or more scripts or when certain thresholds are met in the computing environment, as described above.

FIG. 12 further shows that the method 1200 includes saving the snapshot to memory in the second computing environment 1225. In at least one implementation, saving the snapshot to memory in the second computing environment can allow the second computing environment to recover in the event of an error. Additionally or alternatively, saving the snapshot to memory in the second computing environment can allow for retrieval of additional information. For example, if a customer has input an account number, saving the snapshot to memory can allow the computing environment to look-up the customer's account balance.

FIG. 12 also shows that the method 1200 includes transmitting the snapshot to the first computing environment 1230. In at least one implementation, transmission can occur through any appropriate means of data transmission. For example, transmission can occur over optical lines, electric lines, buses or any other means of data transmission. Additionally or alternatively, transmission can include placing the action within a cache, as described above.

FIG. 12 further shows that the method 1200 includes saving the snapshot to a memory in the first computing environment 1235. In at least one implementation, saving the snapshot to a memory in the first computing environment can allow the first computing environment to resume execution of the script application and the one or more scripts if a failure occurs in the second computing environment.

In at least one implementation, the first computing environment is available to run the script application and the one or more scripts if a failure occurs in the second computing environment. For example, after the first computing environment experiences a failure, the first computing environment can reset or a action manager within the first computing environment can end the application which experienced the failure. The first computing environment can then be made available to execute the script application and the one or more scripts if a failure occurs in the second computing environment.

### V. Example Computing Environment

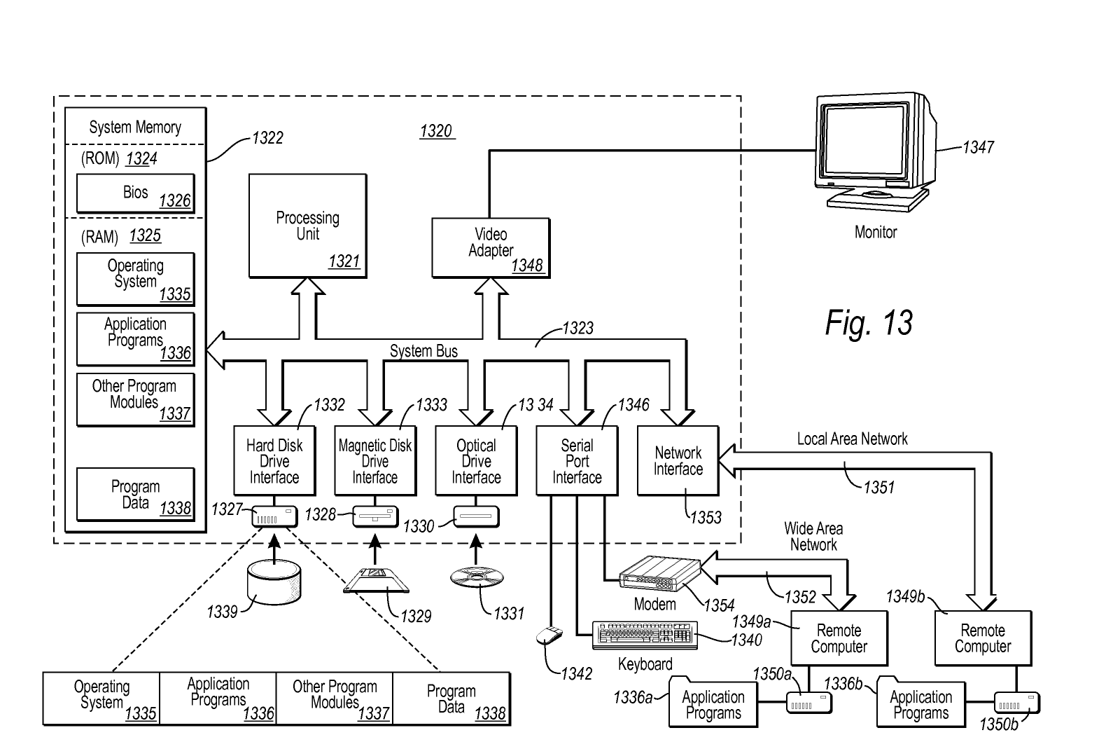

FIG. 13 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular actions or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where actions are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 13, an example system for implementing the invention includes a general purpose computing device in the form of a conventional computer 1320, including a processing unit 1321, a system memory 1322, and a system bus 1323 that couples various system components including the system memory 1322 to the processing unit 1321. It should be noted however, that as mobile phones become more sophisticated, mobile phones are beginning to incorporate many of the components illustrated for conventional computer 1320. Accordingly, with relatively minor adjustments, mostly with respect to input/output devices, the description of conventional computer 1320 applies equally to mobile phones. The system bus 1323 may be any of several types of bus structures including a memory bus or memory controller, a peripheral bus, and a local bus using any of a variety of bus architectures. The system memory includes read only memory (ROM) 1324 and random access memory (RAM) 1325. A basic input/output system (BIOS) 1326, containing the basic routines that help transfer information between elements within the computer 1320, such as during start-up, may be stored in ROM 1324.

The computer 1320 may also include a magnetic hard disk drive 1327 for reading from and writing to a magnetic hard disk 1339, a magnetic disk drive 1328 for reading from or writing to a removable magnetic disk 1329, and an optical disc drive 30 for reading from or writing to removable optical disc 1331 such as a CD-ROM or other optical media. The magnetic hard disk drive 1327, magnetic disk drive 1328, and optical disc drive 1330 are connected to the system bus 1323 by a hard disk drive interface 1332, a magnetic disk drive-interface 1333, and an optical drive interface 1334, respectively. The drives and their associated computer-readable media provide nonvolatile storage of computer-executable instructions, data structures, program modules and other data for the computer 1320. Although the exemplary environment described herein employs a magnetic hard disk 1339, a removable magnetic disk 1329 and a removable optical disc 1331, other types of computer readable media for storing data can be used, including magnetic cassettes, flash memory cards, digital versatile discs, RAMs, ROMs, and the like.

Program code means comprising one or more program modules may be stored on the hard disk 1339, magnetic disk 1329, optical disc 1331, ROM 1324 or RAM 1325, including an operating system 1335, one or more application programs 1336, other program modules 1337, and program data 1338. A user may enter commands and information into the computer 1320 through keyboard 1340, pointing device 1342, or other input devices (not shown), such as a microphone, joy stick, game pad, satellite dish, scanner, or the like. These and other input devices are often connected to the processing unit 1321 through a serial port interface 1346 coupled to system bus 1323. Alternatively, the input devices may be connected by other interfaces, such as a parallel port, a game port or a universal serial bus (USB). A monitor 1347 or another display device is also connected to system bus 1323 via an interface, such as video adapter 1348. In addition to the monitor, personal computers typically include other peripheral output devices (not shown), such as speakers and printers.

The computer 1320 may operate in a networked environment using logical connections to one or more remote computers, such as remote computers 1349a and 1349b. Remote computers 1349a and 1349b may each be another personal computer, a server, a router, a network PC, a peer device or other common network node, and typically include many or all of the elements described above relative to the computer 1320, although only memory storage devices 1350a and 1350b and their associated application programs 1336a and 1336b have been illustrated in FIG. 13. The logical connections depicted in FIG. 13 include a local area network (LAN) 1351 and a wide area network (WAN) 1352 that are presented here by way of example and not limitation. Such networking environments are commonplace in office-wide or enterprise-wide computer networks, intranets and the Internet.

When used in a LAN networking environment, the computer 1320 is connected to the local network 1351 through a network interface or adapter 1353. When used in a WAN networking environment, the computer 1320 may include a modem 1354, a wireless link, or other means for establishing communications over the wide area network 1352, such as the Internet. The modem 1354, which may be internal or external, is connected to the system bus 1323 via the serial port interface 1346. In a networked environment, program modules depicted relative to the computer 1320, or portions thereof, may be stored in the remote memory storage device. It will be appreciated that the network connections shown are exemplary and other means of establishing communications over wide area network 1352 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a contact handling system, including a computing environment and a network for connecting the contact handling system to a customer, a user interface for allowing a business to create a script application from one or more scripts in a visual environment, the user interface comprising:
a script menu, wherein the script menu includes one or more scripts for a business to select from, wherein:
the script includes one or more actions to be accomplished by a script application;
the one or more actions are represented in the graphical user interface as icons which can be manipulated by the business; and
the icons include a visual representation of branches within each of the one or more scripts, wherein the branches represent options that can be selected by a customer in communication with a contact handling system if the script includes a customer selectable option; and
the branches are configured to connect to an additional script; and
a frame, wherein the frame is configured to allow a business to visualize the one or more scripts and to assemble the one or more scripts into the script application.

2. The user interface according to claim 1, wherein the user interface further comprises: p1 a script modification menu, wherein the script modification menu includes one or more actions for the business to select from and wherein the one or more actions are represented in the graphical user interface as icons which can be manipulated by the business.

3. The user interface according to claim 2, wherein the one or more script actions are represented in the graphical user interface as icons which can be manipulated by the business; and
wherein the business can place the action icons within the script.

4. The user interface according to claim 1, wherein the computing environment further includes a per-action compiler, wherein the per-action compiler includes:
a compiling module configured to compile scripts, wherein the compiling module compiles each of the one or more script actions individually and wherein compiling each of the one or more script actions individually includes translating each action of the script from source code to machine code; and
a saving module configured to save each of the one or more compiled scripts to a memory.

5. In a contact handling system, including a computing environment and a network for connecting the contact handling system to a customer, a method for compiling one or more scripts independent of one another and on a per-action basis and in a manner that conserves computing resources in the computing environment, the method comprising:
receiving a script, wherein the script includes one or more actions to be accomplished by a script application;
determining whether the script has been previously compiled;
determining whether the script has been changed since it was last compiled;
retrieving the compiled script from a memory if the script was previously compiled and if the script has not been changed since it was last compiled;
compiling the script if it has not been previously compiled or if the script has been changed since it was last compiled, wherein compiling the script includes:
translating the script from source code to machine code;
saving the script to the memory; and
identifying the script as compiled; and
executing the one or more actions of the compiled script.

6. The method according to claim 5, wherein the script includes a header which identifies whether the script has been previously compiled and whether the script has been changed since previously being compiled.

7. The method according to claim 6, wherein identifying the script as compiled includes updating the header of the script.

8. The method according to claim 5, wherein the method further includes creating a table which identifies whether the script has been previously compiled and whether the script has been changed since previously being compiled.

9. The method according to claim 8, wherein identifying the script as compiled includes updating the header of the script.

10. The method according to claim 5, wherein the method further includes creating a first list which identifies scripts that have been previously compiled.

11. The method according to claim 10, wherein the method further comprising creating a second list which identifies scripts that have been changed since they were compiled.

12. The method according to claim 11, wherein identifying the script as compiled includes:
adding the script to the first list if the script is compiled; and
removing the script from the second list if the script is compiled.

13. The method according to claim 5, wherein one of the one or more scripts include actions to obtain information from a customer.

14. The method according to claim 13, wherein the one of the one or more scripts includes a prompt for the customer to enter the information using their telephone keypad.

15. The method according to claim 13, wherein the one of the one or more scripts includes:
speech recognition software; and
a prompt for the customer to speak the information aloud.

16. In a contact handling system, including a computing environment and a network for connecting the contact handling system to a customer, a computing system for per-action compiling one or more scripts independent of one another and on a per-action basis and in a manner that conserves computing resources in the computing environment, the computing system comprising:
a receiver module, wherein the receiver module is configured to receive a script, wherein the script includes one or more actions to be accomplished by a script application;
a determination module, wherein the determination module is configured to:
determine whether the script has been previously compiled; and
determine whether the script has been changed since it was last compiled;
a retrieval module, wherein the retrieval module is configured to retrieve the compiled script from a memory if the script was previously compiled and if the script has not been changed since it was last compiled; and
a compiling module, wherein the compiling module is configured to compile the script if it has not been previously compiled or if the script has been changed since it was last compiled, wherein compiling the script includes:
translating the script actions from source code to machine code;
saving the machine code of the script actions to the memory; and
identifying the script as compiled.

17. The computing system according to claim 16, wherein the computing system further includes an execution module, wherein the execution module is configured to execute the script application and at least one of the one or more compiled scripts.

18. The computing system according to claim 17, wherein the execution module is configured to connect a customer to a business representative.

19. The computing system according to claim 17, wherein the execution module is configured to communicate with a customer.

20. The computing system according to claim 18, wherein the logic device includes a field-programmable gate array.
